(19) United States
(12) Patent Application Publication
(10) Pub. No.: US 2015/0131205 A1
(43) Pub. Date: May 14, 2015

(54) HYBRID CAPACITOR

(71) Applicant: Dyson Technology Limited, Wiltshire (GB)

(72) Inventors: Gehan Anjil Joseph Amaratunga, Cambridge (GB); Youngjin Choi, Cambridge (GB); Sai Giridhar Shivareddy, Cambridge (GB); Nathan Charles Bromn, Swindon (GB); Charles Anthony Neild Collis, Gloucester (GB)

(73) Assignee: Dyson Technology Limited, Wiltshire (GB)

(21) Appl. No.: 14/398,667

(22) PCT Filed: Apr. 25, 2013
(86) PCT No.: PCT/GB2013/051050

§ 371 Date: Nov. 3, 2014

(30) Foreign Application Priority Data
May 3, 2012 (GB) 1207763.2

(51) Int. Cl. H01G 11/36; H01G 11/86; H01G 11/58; H01G 11/52; H01G 11/04

(52) U.S. Cl. CPC H01G 11/36; H01G 11/52; H01G 11/04; H01G 11/58; H01G 11/86
USPC 361/502; 427/80

(57) ABSTRACT

Disclosed is a capacitor (200) comprising a first structured surface having a dielectric coating (230), a second structured surface having a dielectric coating (230), a separator (240) provided between the first structured surface and the second structured surface, and an electrolyte provided between the first structured surface and the second structured surface. The structured surface may be formed from carbon which may be a random array of carbon nanotubes having a spacing to length ratio of the carbon nanotubes is not greater than 1:30. The dielectric coating may be selected from but not limited to hafnium oxide, barium titanate (BTO), BST, PZT, CCTO or titanium dioxide or a combination of two or more such materials.

### REFERENCE TO RELATED APPLICATIONS

This application is a national stage application under 35 USC 371 of International Application No. PCT/GB2013/051050, filed Apr. 25, 2013, which claims the priority of United Kingdom Application No. 1207763.2, filed May 3, 2012, the entire contents of which are incorporated herein by reference.

### FIELD OF THE INVENTION

This invention relates to a hybrid capacitor.

### BACKGROUND OF THE INVENTION

Capacitors store electric charge between two metallic surfaces. Capacitors can be broadly classified as electrostatic, electrolytic or electrochemical based on the way the capacitor is constructed and the material used between the two metallic surfaces. In standard electrostatic capacitors, two metallic electrodes are separated by a dielectric material and the charge is stored between the electrodes. Electrolytic capacitors comprise two metallic electrodes, one of which is coated with an insulating dielectric that is an oxide of the metallic electrode, and a paper spacer soaked in an electrolyte. The metal electrode insulated by the oxide layer provides the anode (positive electrode), while the liquid electrolyte and the second metallic surface provide the cathode (negative electrode).

Electrochemical capacitors, also referred to as double layer capacitors or supercapacitors, normally consist of two identical metal electrodes, each coated with a high surface area conducting carbon, soaked in an electrolyte and separated by a spacer. Electrochemical capacitors have a capacitance (greater than 100 F/g or greater than 100 μF/cm²) which is many orders of magnitude higher than the capacitance of both electrolytic capacitors (which typically have a capacitance of a few uF/cm²) and electrostatic capacitors (which typically have a capacitance of the order of nF/cm²). However, the maximum operation voltage, and the speed of charging and discharging, increases considerably from electrochemical capacitors (about 3V for capacitors having an organic electrolyte) to electrolytic and electrostatic capacitors (from tens to hundreds of volts).

Capacitors have very high power densities compared to batteries but much lower energy densities. The electric energy (U) stored in a capacitor varies depending on its capacitance (C) and the square of the maximum voltage (V) at which it can operate, and is given by the relation U=½ CV². To increase the energy stored in the capacitor, both the capacitance and the operating voltage have to be increased. Electrochemical supercapacitors have a very high capacitance but a low operating voltage, whereas electrostatic dielectric capacitors have lower capacitances but much higher operating voltages.

### SUMMARY OF THE INVENTION

According to a first aspect the invention provides a capacitor comprising a first structured surface having a dielectric coating, a second structured surface having a dielectric coating, a separator disposed between the first structured surface and the second structured surface, and an electrolyte disposed between the first structured surface and the second structured surface.

This invention relates to a capacitor which is a hybrid of dielectric and electrochemical capacitors, in that it employs dielectric coated surfaces, preferably formed from structured high surface area carbon material, and is constructed in the conventional manner of electrochemical supercapacitors, hence obtaining capacitances that are similar to those of supercapacitors but with higher operation voltages. Consequently, the energy stored in the hybrid capacitor will be improved. This construction is different from that of an electrolytic capacitor, as it employs high surface area carbon surfaces and the insulating oxide is not the metal oxide that is formed from the metal of the electrode. This can make this capacitor structure more robust and non polar.

The structured surface is preferably a conducting structure, and preferably comprises an electrode of the capacitor. For example, the structured surface preferably has a three-dimensional surface which increases the surface area of the electrode for charge transfer. Examples of a structured nanosurface are crumpled plates of porous carbon, and activated carbon.

Preferably, the structured surface is a nanostructured carbon surface. It is preferred that the nanostructured carbon surfaces comprises a carbon nanotube (CNT) array.

According to a second aspect, the invention provides a method of manufacturing a capacitor, comprising the steps of:
a. providing a first structured surface having a dielectric coating;
b. providing a second structured surface having a dielectric coating;
c. disposing a separator between the first structured surface and the second structured surface; and
d. disposing an electrolyte between the first structured surface and the second structured surface.

It is preferred that the structured surface is formed from carbon. Preferably the structured surface is an array of CNTs. The array may be a regular array or a random array. It is preferred that a chemical vapour deposition (CVD) process is used to produce the CNTs. In one example, a D.C. plasma enhanced CVD growth chamber was used to produce oriented nanotubes.

For the production of a regular array of CNTs, a substrate may be lithographically prepared to promote the growth of the CNTs only in specified positions. One preferred growth process consists of four stages:
(a) a substrate pre-treatment (forming a diffusion barrier), where silicon is sputtered with a 30 nm thick layer of niobium;
(b) a catalyst deposition, where a 10 nm thick film of nickel catalyst is deposited onto the substrate;
(c) a catalyst annealing (sintering) stage, where the substrate is heated to 700° C. and held for 10 min to sinter the catalyst layer and to form islands or nano-spheres of the catalyst; and
(d) a nanotube growth, where 200 sccm flow of NH₃ is introduced, a dc discharge between a cathode (the substrate) and an anode is initiated, the bias voltage is increased to −600 V, and a 60 sccm flow of acetylene (C₂H₂) feed gas is introduced.

In one example, the total pressure was maintained at 3.8 mbar and the depositions were carried out for 10 min in a stable discharge.

In a preferred embodiment, the first electrode comprises a random array of structures, preferably CNTs. Such a random array is also known as supergrowth and has a significantly higher growth rate than a regular array. Preferably, the spacing to length ratio of the structures has a maximum of 1:30. If the structures are too long for a given density, then the dielectric coating becomes non-conformal, resulting in a discontinuous dielectric layer. In addition, if the structures are too long and dense, then it can be difficult to form both the dielectric layer and the second electrode layer on top of the structures.

For supergrowth or random CNTs, a preferred growth process is as follows:
(a) a substrate is coated with a 2-4nm thick layer of aluminium;
(b) a 2-4 nm thick film of iron (Fe) catalyst is sputtered on the aluminium layer, using a metal sputter coating equipment with a base pressure of 10⁻⁵ mbar; and
(c) the coated substrate is annealed at 600° C. within an NH₃ environment for 10 minutes, and then 2 sccm C₂H₂ is introduced into the chamber to grow CNTs.

The CNT growth stage preferably has a duration which is no greater than 10 minutes, preferably between 1 and 10 minutes, even more preferably between 1 and 3 minutes. The aluminium layer is a barrier layer, and is used to form a thin alumina layer during the annealing process step. This thin oxide layer assists in forming iron nano-islands to grow CNTs in a high density. The substrate may be any conductive substrate. Preferably, the substrate is a copper or a silicon substrate. Alternatively, the substrate may be a graphite substrate.

A hybrid capacitor is a capacitor that combines solid state capacitor technology materials with a liquid electrolyte in an attempt to maximise desirable properties of the resultant capacitor. It has been found that the voltage window of the capacitor can be increased from around 2.8V for a conventional liquid electrolyte capacitor to 5V or more.

The dielectric coating may be formed from at least one of hafnium oxide, barium titanate, barium strontium titanate, lead zirconate titanate, CaCu₃Ti₄O₁₂, and titanium dioxide. It is preferred that the dielectric is a high k metal oxide such as hafnium oxide, titanium dioxide, barium titanate (BTO), or barium strontium titanate. Such coatings can be produced by various methods including but not limited to atomic layer deposition (ALD), plasma enhanced ALD (PEALD), electrophoretic deposition (EPD), physical vapour deposition (PVD), pulsed laser deposition (PLD), metal organic chemical vapour deposition (MOCVD), plasma enhanced chemical vapour deposition (PECVD) and sputter coating.

In addition various polymer materials having relatively high K values can be used to form the dielectric, such as cyanoresins (CR-S), polyvinylidene fluoride-based polymers such as Pvdf: Trfe, or PVDF:TrFE:CFE, which can be spin coated onto the BTO coated CNTs. Self assembled monolayer coatings of phosphonic acids can also function as an additional coating to further reduce the leakage current.

The ALD process may comprise a plurality of deposition cycles, with each deposition cycle comprising the steps of (i) introducing a precursor to a process chamber, (ii) purging the process chamber using a purge gas, (iii) introducing an oxygen source as a second precursor to the process chamber, and (iv) purging the process chamber using the purge gas. The oxygen source may be one of oxygen and ozone. The purge gas may be argon, nitrogen or helium. To deposit hafnium oxide, an alkylamino hafnium compound precursor may be used. To deposit titanium dioxide, a titanium isopropoxide precursor may be used. Each deposition cycle is preferably performed with the substrate at the same temperature, which is preferably in the range from 200 to 300° C., for example 250° C. Each deposition step preferably comprises at least 100 deposition cycles. For example, an ALD deposition may comprise 200 to 400 deposition cycles to produce a hafnium oxide coating having a thickness in the range from 25 to 50 nm Where the deposition cycle is a plasma enhanced deposition cycle, step (iii) above preferably also includes striking a plasma, for example from argon or from a mixture of argon and one or more other gases, such as nitrogen, oxygen and hydrogen, before the oxidizing precursor is supplied to the chamber.

It is preferred that the dielectric coating is produced in a two step ALD process, whereby a first layer of the coating is deposited, followed by a pause in the deposition process and then a second layer of the second coating is deposited. This two step coating is applicable to both plasma only and combined plasma and thermal ALD coating methods. The pause is a break or delay in the deposition process which has been found advantageous to certain properties of the material deposited on the substrate. The delay preferably has a duration of at least one minute. The delay is preferably introduced to the deposition by supplying a purge gas to a process chamber in which the substrate is located for a period of time of at least one minute between the first deposition step and the second deposition step. Each deposition step preferably comprises a plurality of consecutive deposition cycles. Each of the deposition steps preferably comprise at least fifty deposition cycles, and at least one of the deposition steps may comprise at least one hundred deposition cycles. In one example, each of the deposition steps comprises two hundred consecutive deposition cycles. The duration of the delay between the deposition steps is preferably longer than the duration of each deposition cycle. The duration of each deposition cycle is preferably in the range from 40 to 50 seconds.

The delay between deposition steps may be provided by a prolonged duration of a period of time for which purge gas is supplied to the process chamber at the end of a selected one of the deposition cycles. This selected deposition cycle may occur towards the start of the deposition process, towards the end of the deposition cycle, or substantially midway through the deposition process.

Electrophoresis is the motion of dispersed particles in a solvent under the influence of an electric field. This phenomenon is utilised in electrophoretic deposition (EPD) to coat a substrate with charged particles. EPD has been used to deposit coatings onto planer substrates for example as described in the following publications: Fabrication of Ferroelectric BaTiO3 Films by Electrophoretic Deposition Jpn. J. Appl. Phys. 32 (1993) pp. 4182-4185 by Soichiro Okamura, Takeyo Tsukamoto and Nobuyuki Koura; and Preparation of a Monodispersed Suspension of Barium Titanate Nanoparticles and Electrophoretic Deposition of Thin Films. Journal of the American Ceramic Society, 87: 1578-1581(2004), doi: 10.1111/j.1551-2916.2004.01578.x by 2. Li, J., Wu, Y. J., Tanaka, H., Yamamoto, T. and Kuwabara, M; and Low-temperature synthesis of barium titanate thin films by nanoparticles electrophoretic deposition, JOURNAL OF ELECTROCERAMICS Volume 21, Numbers 1-4, 189-192, DOI: 10.1007/s10832-007-9106-6 by Yong Jun Wu, Juan Li, Tomomi Koga and Makoto Kuwabara,

The structured surface having a dielectric coating may be produced by the steps of:
(a) providing nanoparticles of a coating material; and
(b) depositing the nanoparticles onto a structured surface using electrophoretic deposition.

The inventors have established that the EPD process is advantageous for use with structured surfaces that exhibit metallic behaviours as unlike other techniques e.g. spin coating and dip coating, EPD has been found to produce a conformal coating on micro and nano structured substrates.

In a preferred embodiment, the coating material is barium titanate (BaTiO₃). Preferably, the particle size of the barium titanate is in the range of 70-150 nm. More preferably, the nanoparticles are barium titanate nanoparticles which are 5-20 nm in diameter.

In one embodiment, the nanoparticles are agitated ultrasonically prior to being deposited onto the structured surface. This ultrasonic agitation shatters the nanoparticles into smaller particles, providing better coverage or a more conformal coating of the structured surface.

Preferably, the dielectric coating comprises a first layer and a second layer. It is preferred that the first layer is deposited onto one of the structured surfaces using EPD. Preferably, the dielectric coating is barium titanate.

Preferably, the second layer is deposited using ALD. It is preferred that the second layer is hafnium oxide. Alternatively, the second layer may be deposited by PLD. In this case, the second layer may be barium titanate.

The electrolyte may be an aqueous electrolyte, such as KOH, hydrochloric acid or sulphuric acid, or an organic electrolyte such as tetra ethyl ammonium tetra fluoroborate salt in an organic solvent such as propylene carbonate or acetonitrile. Preferably, the operating voltage is at least 5V.

### BRIEF DESCRIPTION OF THE DRAWINGS

The invention will now be described by way of example with reference to the accompanying drawings, of which:

FIG. 1 illustrates schematically a capacitor according to the invention;

FIG. 2 illustrates schematically a cross section of the capacitor structure when the structured metal surface is an array of aligned or random nanotubes;

FIGS. 3a, 3c and 3e show scanning electron images of random nanotubes grown by CVD;

FIGS. 3b, 3d and 3f show the same nanotubes as shown in FIGS. 3a, 3c and 3e respectively after they are coated with an aluminium oxide dielectric using an ALD process;

FIG. 4 is a graph illustrating impedance spectroscopy of hybrid supercapacitors fabricated with different thickness of aluminium oxide on random nanotubes;

FIGS. 5a and 5b are cyclic voltametry graphs for uncoated and aluminium oxide coated CNTs; and

FIG. 6 is a graph showing capacitance retention for capacitors comprising uncoated and aluminium oxide coated CNTs.

### DETAILED DESCRIPTION OF THE INVENTION

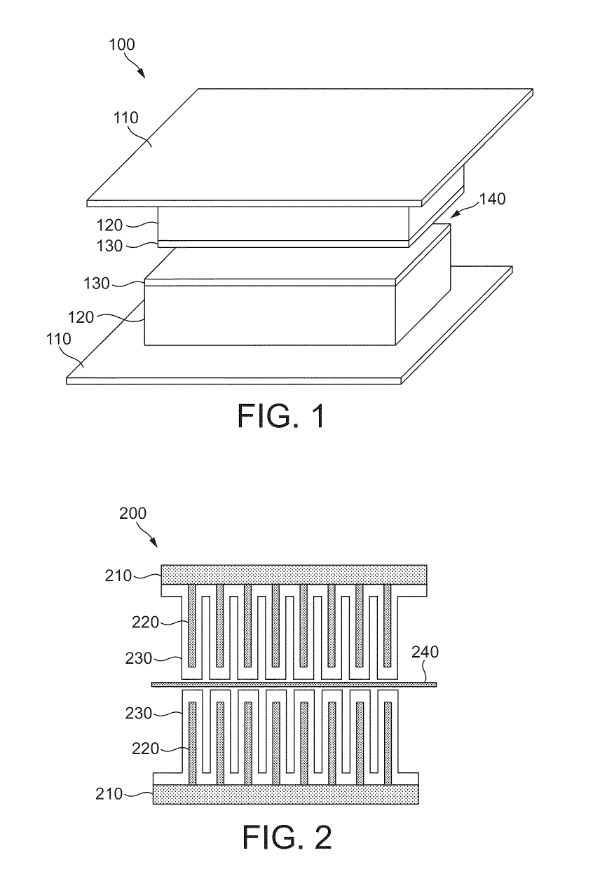

FIG. 1 illustrates schematically a hybrid capacitor 100 having two substantially parallel electrodes 110 each having a dielectric layer 120 deposited onto a first surface. When the capacitor is assembled, the first surfaces face each other. An electrolyte 130 is provided on either side of a separator 140 (not shown but located between two areas of electrolyte 130).

FIG. 2 illustrates schematically a hybrid capacitor 200 having two electrodes of carbon nanotubes 220 formed on a metal thin film 210 and coated conformally by a dielectric 230, and a separator 240 soaked in an electrolyte. As an example, the separator is cellulose and the electrolyte TEABF4 in propylene carbonate.

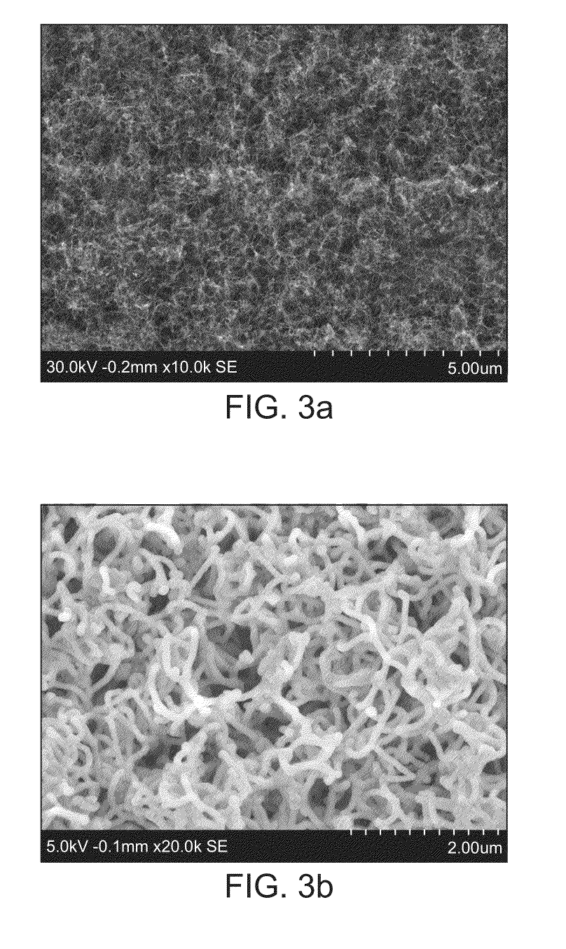

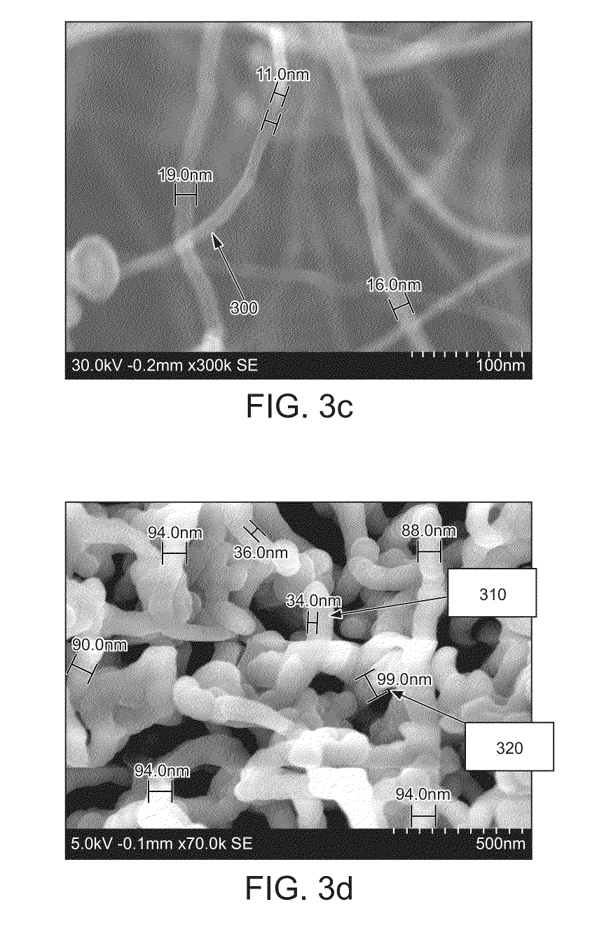

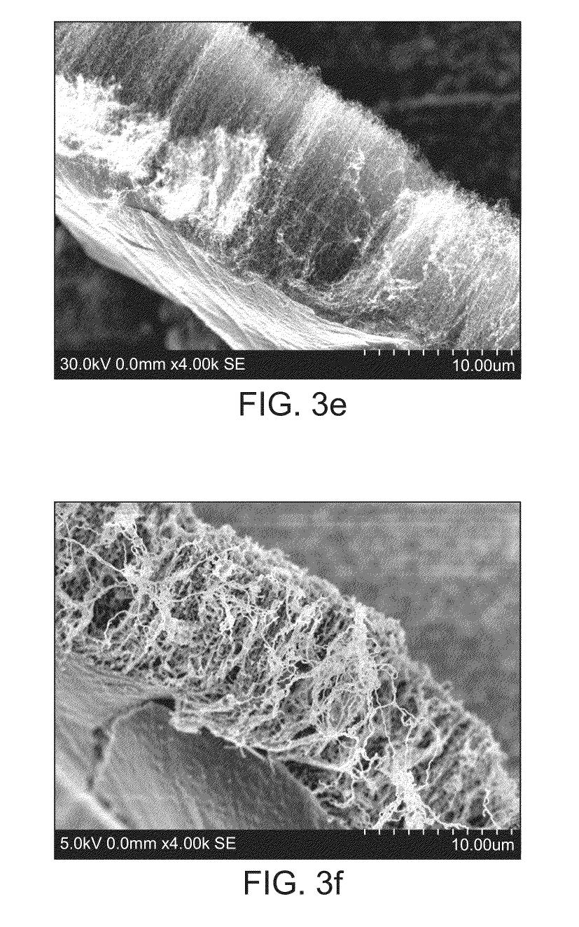

FIGS. 3a, 3c and 3e are scanning electron images of multi-walled nanotubes 300 grown by CVD at 570° C. for 3 minutes, which are 10-20 nm in diameter and 15 μm in length and grown on a copper foil.

These carbon nanotubes are curly and form a tangled structure. The method of growing these nanotubes is much faster than for a regular and straight array of CNTs and is called supergrowth. Although the curly or supergrowth CNTs are irregular, the supergrowth CNTs have a much higher surface area, and there is plenty of room between the individual CNTs for the electrolyte to penetrate.

For supergrowth or random CNTs the growth process is as follows:
(a) a substrate is coated with a layer of aluminium that is approximately 2-4 nm thick;
(b) a thin film, approximately 2-4 nm thick, of iron (Fe) catalyst is sputtered on the aluminium using a metal sputter coating equipment with a base pressure of 10⁻⁵ mbar;
(c) the coated substrate is annealed at 600° C. in a 198 sccm NH₃ environment for 10 minutes and then 2 sccm C₂H₂ is introduced into the chamber to grow CNTs.

The CNT growth stage is preferably up to 10 minutes duration, more preferably between 1 and 10 minutes in duration, even more preferably between 1 and 3 minutes in duration. The aluminium is a barrier layer and is used to form a thin alumina layer during the annealing process step and this thin oxide layer helps in forming iron nano-islands to grow CNTs in a high density. Preferably, the substrate is a copper or a silicon substrate.

The annealing stage can be carried out at temperatures of up to 650° C. and the system pressure is preferably around 25 mbar.

FIGS. 3b, 3d and 3f show supergrowth multiwalled nanotubes 300 coated with aluminium oxide by an atomic layer deposition process to form conformally dielectric coated nanostructured electrodes 310. Each ALD process was conducted using a Cambridge Nanotech Fiji 200 plasma ALD system. The substrate was located in a process chamber of the ALD system which was evacuated to a pressure in the range from 0.3 to 0.5 mbar during the deposition process, and the substrate was held at a temperature of around 200-250° C. during the deposition process. Argon was selected as a purge gas, and was supplied to the chamber at a flow rate of 200 sccm for a period of at least 30 seconds prior to commencement of the first deposition cycle.

The ALD process used is a thermal ALD process with tri methyl aluminium (TMA) and water as precursors; and the process temperature was 200° C. Different thicknesses of alumina were produced by varying the number of deposition cycles. A first deposition process comprised 100 deposition cycles and produced a 10 nm thick layer of aluminium oxide. A second deposition process comprised 200 deposition cycles and produced a 20 nm thick aluminium oxide coating which resulted in a 50 nm diameter dielectric coated nanotube 310. A third deposition process comprised 400 deposition cycles and produced a 40 nm thick aluminium oxide coating which resulted in a 90 nm diameter dielectric coated nanotube 320. The diameter of the uncoated CNT 300 is about 10 nm

Alternatively, the dielectric coating may be barium titanate, produced by EPD. In a first technique BTO nanoparticles were prepared solvothermally or hydrothermally using barium hydroxide octahydrate and titanium (IV) tetraisopropoxide. The resulting nanoparticles were 5-20 nm in diameter with cubic perovskite phase crystallinity. The reactants were as follows:

Ba(OH)₂+8H₂O+Ti{OCH(CH₃)₂}₄(Titanium isopropoxide)+Ethanol (60 ml)

The solution was placed in a water bath at 50° C. for 4 hours under magnetic stirring. Then the product of the reaction was washed with formic acid, ethanol, and finally de-ionised water and subsequently dried at 50° C. for 6 hours in a vacuum.

In a second technique, commercially available 70-150 nm BTO nanoparticles (available from Sigma-Aldrich) which are generally spherical in shape were subjected to high power ultrasonication which caused shattering of the particles to approximately 20 nm (with a range of 4 nm-25 nm). The larger particles were suspended in water using a tip sonicator at 200W to 250W for 6 to 12 hours. A tip sonicator provides more power per unit volume at the tip than an ultrasonic bath.

This technique is usually carried out using an organic solvent to disperse the particles rather than water, as water dissolves the particles. However, it is thought that particles dissolve in the water and then re-crystallise because of the high energy input at the tip of the tip sonicator to produce sharp fragments of BTO. There is natural circulation of the particles within the suspension due to the tip sonicator so a constant stream of material is provided near the tip. Once the sonication process was complete, the suspension was left for at least one hour to enable settling of the larger particles to the bottom of the suspension.

These nanoparticles were then coated onto regular CNTs using EPD. The coating made using the smaller particles required more time to grow, for example around 2 hours. The smaller particles provide a more conformal coating on the CNT as the particle sizes (around 5-20 nm) are generally smaller than the diameter of a CNT. However, the coated CNTs were still electrically leaky, and this is considered to be due to the coating not being continuous and, as the nanoparticles deposit much better on the nanotubes than on the silicon substrate, which creates a leakage path between the two electrodes. It is important for a capacitor to have a good, complete insulating layer otherwise stored charge will be lost over time. To mitigate this problem, a second coating material was provided. This second coating is preferably a material with a high K value i.e. high permittivity.

Examples of compounds which are suitable for use as the second coating material include, but is not limited to, high k metal oxide coatings such as hafnium oxide, titanium dioxide, barium titanate, and barium strontium titanate, which can be coated by various methods including but not limited to conformal atomic layer deposition (ALD), plasma enhanced ALD (PEALD), physical vapour deposition (PVD), pulsed laser deposition (PLD), metal organic chemical vapour deposition (MOCVD), plasma enhanced chemical vapour deposition (PECVD) and sputter coating. In addition various polymer materials having relatively high K values are available such as cyanoresins (CR-S), polyvinylidene fluoride based polymers like Pvdf: Trfe, PVDF:TrFE:CFE, which can be spin coated onto the BTO coated CNTs. Self assembled monolayer coatings of phosphonic acids can also function as an additional coating to further reduce the leakage current.

A preferred PEALD process to form a hafnium oxide coating comprises a series of deposition cycles. Each deposition cycle commences with a supply of a hafnium precursor to the deposition chamber. The hafnium precursor was tetrakis dimethyl amino hafnium (TDMAHf, Hf(N(CH₃)₂)₄). The hafnium precursor was added to the purge gas for a period of 0.25 seconds. Following the introduction of the hafnium precursor to the chamber, the purge gas was supplied for a further 5 seconds to remove any excess hafnium precursor from the chamber. A plasma was then struck using the argon purge gas. The plasma power level was 300 W. The plasma was stabilised for a period of 5 seconds before oxygen was supplied to the plasma at a flow rate of 20 sccm for a duration of 20 seconds. The plasma power was switched off and the flow of oxygen stopped, and the argon purge gas was supplied for a further 5 seconds to remove any excess oxidizing precursor from the chamber, and to terminate the deposition cycle.

The deposition process was a discontinuous PEALD process, comprising a first deposition step, a second deposition step, and a delay between the first deposition step and the second deposition step. The first deposition step comprised 200 consecutive deposition cycles, again with substantially no delay between the end of one deposition cycle and the start of the next deposition cycle. The second deposition step comprised further 200 consecutive deposition cycles, again with substantially no delay between the end of one deposition cycle and the start of the next deposition cycle. The delay between the final deposition cycle of the first deposition step and the first deposition cycle of the second deposition step was in the range from 1 to 60 minutes. During the delay, the pressure in the chamber was maintained in the range from 0.3 to 0.5 mbar, the substrate was held at a temperature of around 250° C., and the argon purge gas was conveyed continuously to the chamber at 20 sccm. This delay between the deposition steps may also be considered to be an increase in the period of time during which purge gas is supplied to the chamber at the end of a selected deposition cycle. The thicknesses of coatings produced by both deposition processes were around 36 nm

Titanium dioxide coatings have also been deposited onto a BTO coated regular array of CNTs using a discontinuous PEALD process comprising a first deposition step, a second deposition step, and a delay between the first deposition step and the second deposition step. The first deposition step comprised 200 consecutive deposition cycles, again with substantially no delay between the end of one deposition cycle and the start of the next deposition cycle. The second deposition step comprised further 200 consecutive deposition cycles, again with substantially no delay between the end of one deposition cycle and the start of the next deposition cycle. The delay between the final deposition cycle of the first deposition step and the first deposition cycle of the second deposition step was 10 minutes. During the delay, the pressure in the chamber was maintained in the range from 0.3 to 0.5 mbar, the substrate was held at a temperature of around 250° C., and the argon purge gas was conveyed to the chamber at 20 sccm.

A second coating of barium titanate has been produced using PLD. The barium titanate film was deposited at 700° C. in an oxygen partial pressure of 50 mTorr and 1400 laser pulses at 5 Hz repetition rate. A custom made vacuum deposition chamber with a KrF excimer UV laser was used. A laser energy of 1-2 J/cm² and oxygen atmospheres of between 0.06-0.2 mbar (50-150 mTorr) were employed to optimize the perovskite oxide films on multi-walled CNTs utilizing a KrF excimer laser (λ=240 nm) at different repetition rates. After the deposition of the perovskite film, the chamber was cooled at a rate of 10 degree/minute to room temperature in an oxygen atmosphere at 400 mbar (300 Torr). The PLD coating produced was 60 nm thick.

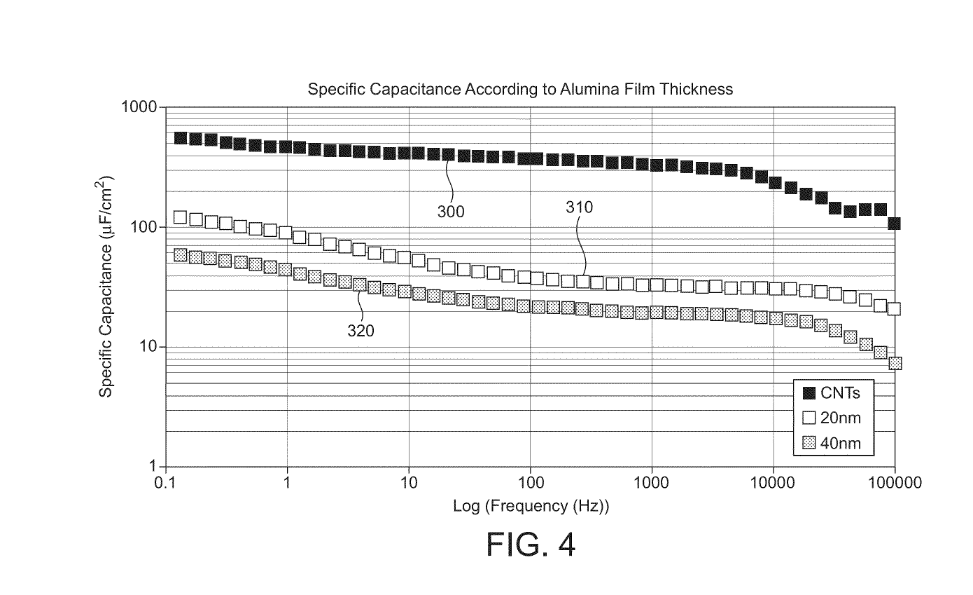

FIG. 4 shows plots of impedance spectra for a hybrid supercapacitor, as illustrated in FIG. 2. Plot 310 was generated by a supercapacitor formed with CNTs coated with a 20 nm thick layer of aluminium oxide, and plot 320 was generated by a supercapacitor formed with CNTs coated with a 40 nm thick layer of aluminium oxide. For comparison, plot 300 was generated by a supercapacitor formed with uncoated CNTs. As shown in FIG. 4, the supercapacitor formed with uncoated CNTs had the highest specific capacitance. For the other supercapacitors, the specific capacitance decreased with increased thickness of the alumina coating. This is to be expects as capacitance is inversely proportional to the thickness of the double layer. The capacitance of the hybrid capacitor is within the order of magnitude of the uncoated CNT electrochemical supercapacitor and much higher than conventional dielectric capacitors.

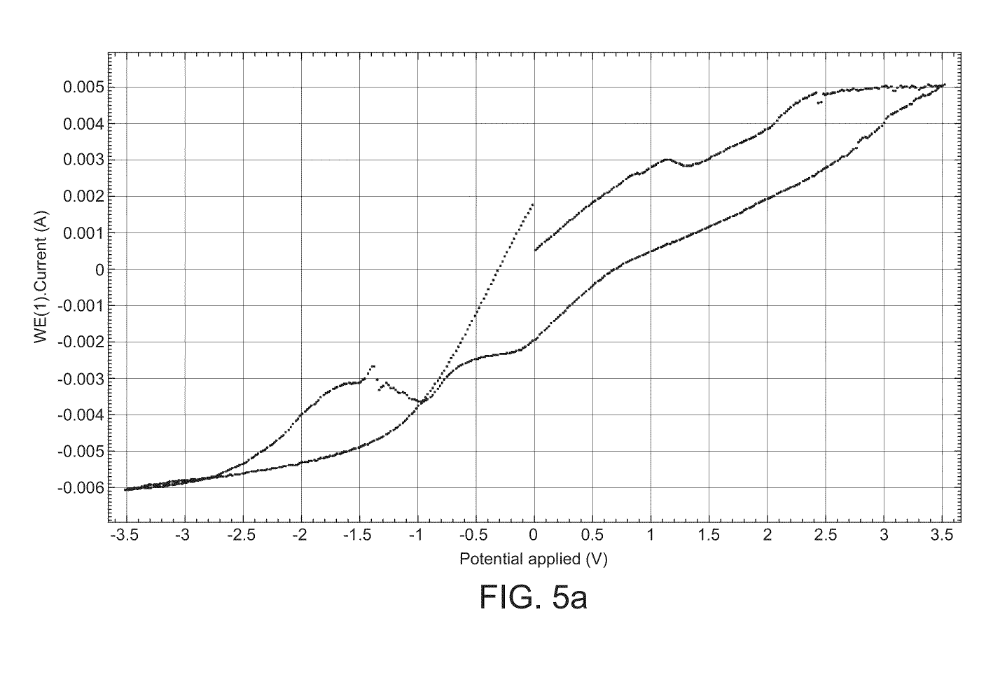

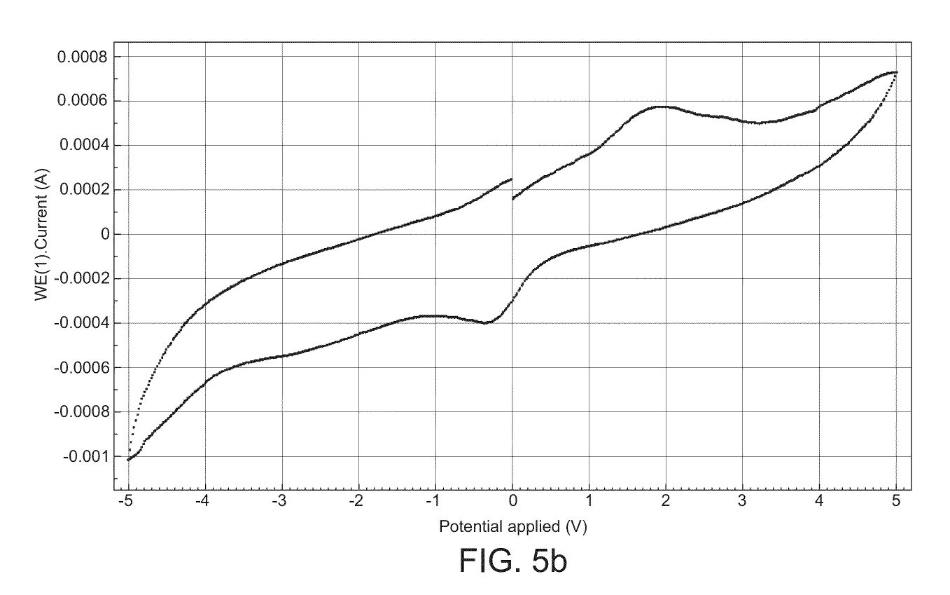

FIG. 5a shows a cyclic voltametry graph for a regular supercapacitor made using uncoated CNTs. The graph shows that there is an interaction between the CNTs and the electrolyte causing the breakdown of the electrolyte beyond 3.5V as expected.

FIG. 5b shows a cyclic voltametry graph for a hybrid supercapacitor made using CNTs coated with 40 nm of alumina. There is no interaction between the CNTs and the electrolyte, as the alumina provides a dielectric layer separating the CNTs and the electrolyte, and as seen in FIG. 5b the hybrid supercapacitor functions even at 5V.

When a voltage is applied between the carbon electrodes there is a certain fraction of the voltage dropping across the dielectric, and the remaining fraction falls between the dielectric and the electrolyte. The operation voltage of any electrochemical capacitor cannot exceed the breakdown voltage across the electrolyte/carbon electrode interface. The operation voltage for standard aqueous electrolytes like KOH or H₂SO₄ is normally 1V and the maximum voltage drop across the electrolyte cannot exceed roughly 3V in organic electrolytes like tetraethylammonium tetraflouroborate (TEABF4) salts in propelyne carbonate. In the case of the hybrid supercapacitor, when a voltage higher than 3V is applied across the electrodes the fraction of the voltage higher than 3V falls across the dielectric, thereby increasing the overall voltage operation of the hybrid capacitor. The maximum voltage at which the hybrid capacitor can operate will depend on the thickness of the dielectric coating on the carbon surface. For a 40 nm alumina film with breakdown strength of 3MV/cm the maximum voltage operation would be around 12V. A 4-fold increase in the operation voltage results in 16-fold increase in the energy density stored in the hybrid capacitor.

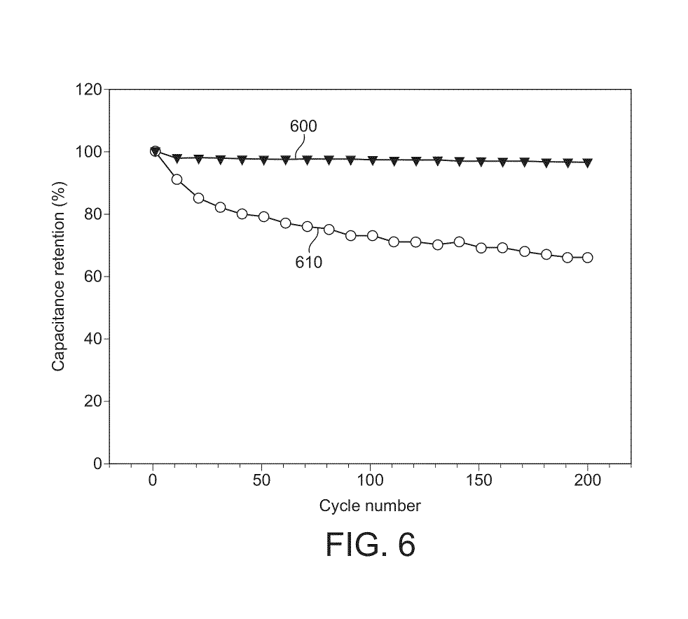

FIG. 6 shows a graph of capacitance retention for a capacitor comprising uncoated CNTs 610 and hybrid capacitor 600 formed from aluminium oxide coated CNTs according to the invention carried out at 4 v. The hybrid capacitor 600 shows improved capacitance retention as the capacitor is cycled through charging and discharging compared with the capacitor formed from uncoated CNTs 610.

1. A capacitor comprising:
a first structured surface formed from carbon nanotubes having a dielectric coating;
a second structured surface having a dielectric coating;
a separator provided between the first structured surface and the second structured surface; and
an electrolyte provided between the first structured surface and the second structured surface.

2. The capacitor of claim 1, wherein the second structured surface is formed from carbon nanotubes.

3. The capacitor of claim 1, wherein the structured surface is a random array of carbon nanotubes.

4. The capacitor of claim 3, wherein the spacing to length ratio of the carbon nanotubes is not greater than 1:30.

5. The capacitor of claim 1, wherein the dielectric coating is formed from at least one of hafnium oxide, barium titanate, barium strontium titanate, lead zirconate titanate, CaCu₃Ti₄O₁₂, and titanium dioxide.

6. The capacitor of claim 1, wherein the electrolyte is organic or aqueous.

7. The capacitor of claim 1, wherein the operating voltage is at least 5V.

8. A method of manufacturing a capacitor, comprising the steps of:
a. providing a first structured surface formed from carbon nanotubes having a dielectric coating;
b. providing a second structured surface having a dielectric coating;
c. disposing a separator between the first structured surface and the second structured surface; and
d. disposing an electrolyte between the first structured surface and the second structured surface.

9. The method according to of claim 8, wherein the dielectric coating comprises a first layer and a second layer.

10. The method of claim 9, wherein the first layer is deposited onto one of the structured surfaces using electrophoretic deposition.

11. The method of claim 10, wherein the dielectric coating is formed from barium titanate.

12. The method of claim 8, wherein the second layer is deposited using an atomic layer deposition process.

13. The method of claim 12, wherein the second layer is formed from hafnium oxide.

14. The method of claim 8, wherein the second layer is deposited by a pulse laser deposition process.

15. The method of claim 14, wherein the second layer is formed from barium titanate.

16. The method of claim 8, wherein the second structured surface is formed from carbon nanotubes.

17. The capacitor of claim 2, wherein the structured surface is a random array of carbon nanotubes.
